(19) United States
(12) Patent Application Publication
(10) Pub. No.: US 2015/0103572 A1
(43) Pub. Date: Apr. 16, 2015

(54) INVERTING APPARATUS AND CONTROL METHOD THEREOF

(71) Applicant: AU OPTRONICS CORP., Hsinchu (TW)

(72) Inventor: Yuan-Bor JEAN, HSIN-CHU (TW)

(73) Assignee: AU OPTRONICS CORP., Hsinchu (TW)

(21) Appl. No.: 14/284,789

(22) Filed: May 22, 2014

(30) Foreign Application Priority Data
Oct. 11, 2013 (CN) 201310473976.6

(51) Int. Cl. H02M 1/32; H02M 7/04

(52) U.S. Cl. CPC H02M 1/32; H02M 7/04
USPC 363/55

(57) ABSTRACT

An inverting apparatus and a control method thereof are disclosed herein. The inverting apparatus includes an inverter. The inverter is configured to convert electrical energy to an output current so as to generate an output terminal voltage. When the output current increases, the output terminal voltage increases correspondingly. The inverter includes a control unit. When the output terminal voltage increases and falls within an alert range, the control unit is configured to control the inverter to decrease the output current or maintain the current output current so as to prevent the output terminal voltage from increasing and exceeding a voltage threshold value that causes the inverter to fall into a trip protection mechanism.

### RELATED APPLICATIONS

This application claims priority to Chinese Application Serial Number 201310473976.6, filed Oct. 11, 2013, which is herein incorporated by reference.

### BACKGROUND

1. Field of Invention

The present invention relates to an inverting apparatus and a control method thereof. More particularly, the present invention relates to an inverting apparatus and a control method thereof for a renewable energy system.

2. Description of Related Art

In recent years, the utilization of renewable energy has gradually become one of the most important technologies in modern society. In order to effectively use renewable energy, an inverter is usually required to convert the electrical energy generated from the renewable energy to an effective alternating current (AC), and then the alternating current is fed into the mains electricity supply through a feeder.

However, the impedance of the feeder increases with aging and the rising temperature so that the current fed into the feeder generates a non-ignorable voltage difference between the two terminals of the feeder. The output terminal voltage of the inverter thus increases (higher than the voltage at the point of common coupling). Generally speaking, a traditional inverter has the functions that a maximum power point tracking device and an anti-islanding trip protection mechanism have to allow the inverter to convert the electrical energy as much as possible in normal mains electricity supply operation, and stop power generation when the mains electricity supply is in an abnormal operating state (for example, the output terminal voltage increases and exceeds the normal voltage range defined by electrical regulations) so as to avoid maintenance personnel casualties and at the same time reduce losses. However, when the over voltage is caused by the voltage difference effect because of the impedance of the feeder rather than the abnormal condition of mains electricity supply, the inverter usually operates alternatively in either the normal power supply mode or the trip protection mode, thus resulting in considerable power generation losses in a renewable energy system.

### SUMMARY

One embodiment of present invention is to provide an inverting apparatus and a control method thereof so as to avoid the inverter operating alternatively in either the normal power supply mode or the trip protection mode because of the voltage difference effect caused by the impedance of the feeder. By controlling the control unit to control the output current of the inverter, the output terminal voltage is prevented from increasing and exceeding the alert range so as to avoid that the inverter falls into the trip protection mechanism. When the output terminal voltage increases and falls within the alert range, the control unit will maintain, increase, or reduce the amount of output current received from the renewable energy. As a result, the quality of current generated by the inverter is effectively maintained to avoid the power generation losses of a renewable system.

According to the first embodiment of present invention, an inverting apparatus is provided. The inverting apparatus comprises an inverter. The inverter is configured to convert electrical energy to an output current so as to generate an output terminal voltage. The output terminal voltage increases correspondingly when the output current increases. The inverter has a control unit configured to control the inverter to decrease the output current or maintain the current output current when the output terminal voltage increases and falls within an alert range so as to prevent the output terminal voltage from increasing and exceeding a voltage threshold value which causes the inverter to fall into a trip protection mechanism.

The other embodiment of present invention provides a control method of an inverting apparatus. The control method comprises: converting electrical energy to an output current so as to generate an output terminal voltage; and controlling an inverter to decrease the output current or maintain the current output current when the output terminal voltage increases with increasing of the output current and falls within an alert range so as to prevent the output terminal voltage from increasing and exceeding a voltage threshold value which causes the inverter to fall into a trip protection mechanism.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A depicts a schematic diagram of an inverting apparatus according to one embodiment of this invention;

FIG. 1B depicts a schematic diagram of an inverting apparatus according to another embodiment of this invention;

FIG. 2A depicts a schematic diagram of an inverting apparatus according to still another embodiment of this invention;

FIG. 2B depicts a schematic diagram of an inverting apparatus according to yet another embodiment of this invention;

FIG. 2C depicts a schematic diagram of cooperation between inverting apparatuses according to one embodiment of this invention;

FIG. 2D depicts a schematic diagram of a relationship between an output terminal voltage of an inverter and time according to one embodiment of this invention;

FIG. 3 depicts a flow chart of a control method of an inverting apparatus according to one embodiment of this invention;

FIG. 4 depicts a flow chart of a control method of an inverting apparatus according to another embodiment of this invention;

FIG. 5 depicts a flow chart of a control method of an inverting apparatus according to still another embodiment of this invention;

FIG. 6 depicts a flow chart of a control method of an inverting apparatus according to yet another embodiment of this invention; and

FIG. 7 depicts a flow chart of a control method of an inverting apparatus according to another embodiment of this invention.

### DESCRIPTION OF THE EMBODIMENTS

Various embodiments are described below to explain this invention. However, these embodiments are not intended to limit the application or methods of the present invention in any specific context. Therefore, descriptions of the embodiments are only intended to illustrate rather than to limit the present invention. It should be noted that, in the following embodiments and attached drawings, elements not directly related to this invention are omitted from depiction, and the dimensional relationships depicted among various elements are only for purposes of illustration, rather than limiting the practical implementation of these elements.

As used herein, both “couple” and “connect” refer to direct physical contact or electrical contact or indirect physical contact or electrical contact between two or more components. Or they can also refer to reciprocal operations or actions between two or more components.

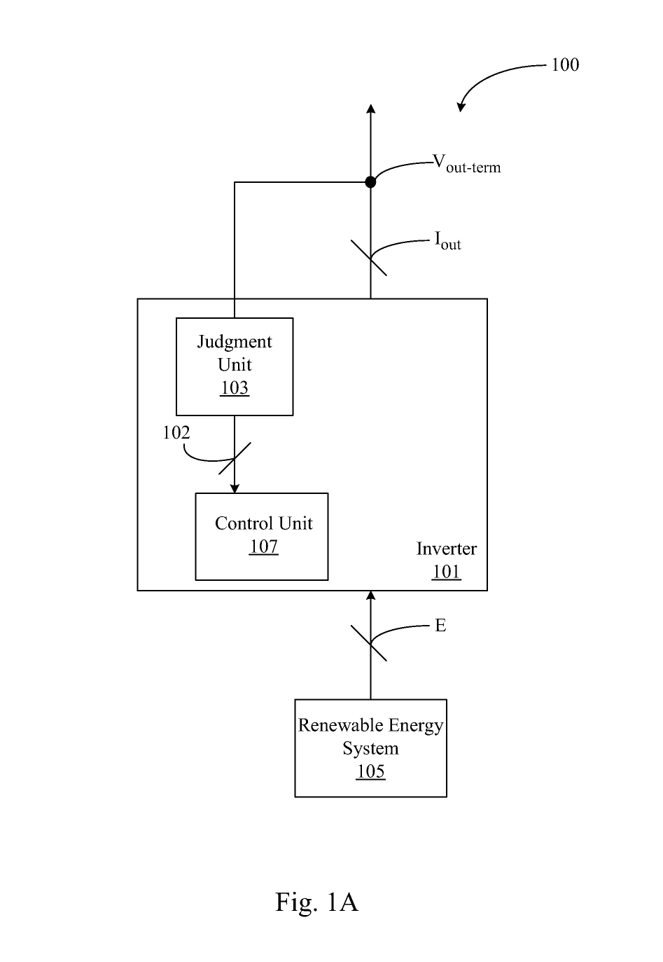

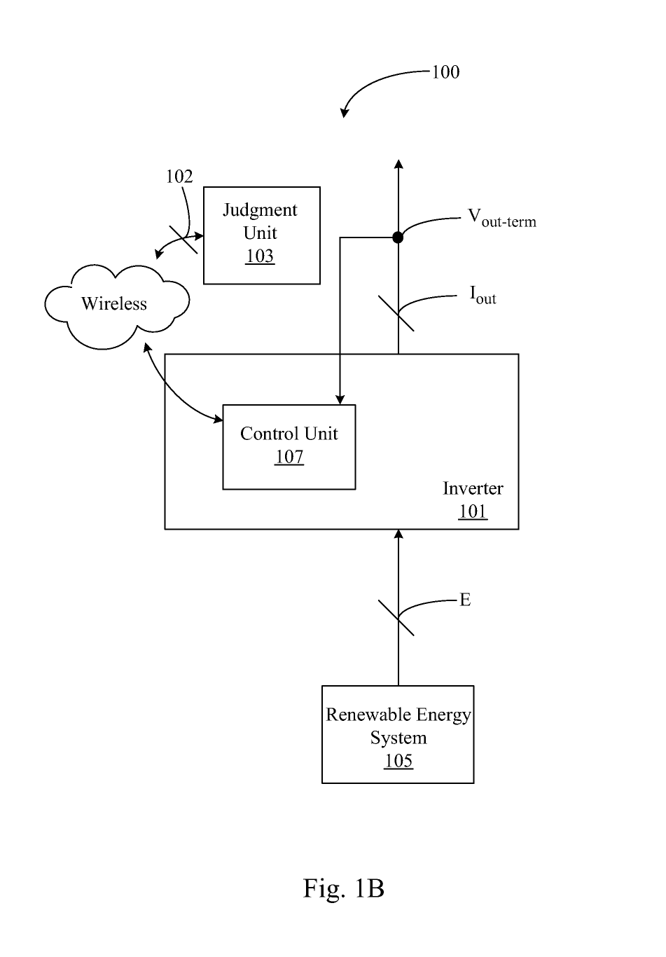

FIG. 1A depicts a schematic diagram of an inverting apparatus according to one embodiment of this invention. FIG. 1B depicts a schematic diagram of an inverting apparatus according to another embodiment of this invention.

As shown in FIG. 1A, a renewable energy system 105 converts nature energy to electrical energy E and transmits the electrical energy E to an inverter 101.

In the present embodiment, the inverting apparatus 100 comprises the inverter 101. The inverter 101 receives the electrical energy E from the renewable energy system 105 and converts the electrical energy E to an output current Iₒᵤₜ so as to generate an output terminal voltage Vₒᵤₜ₋ₜₑᵣₘ. It is noted that the output terminal voltage Vₒᵤₜ₋ₜₑᵣₘ is a voltage relative to the output current Iₒᵤₜ and an external impedance (not shown in the figure) at an output terminal not generated from the inverter 101. In greater detail, the connection between the output terminal of the inverter 101 and mains electricity supply (e.g., 110-120V/60 Hz, 220-240V/50 Hz) has the external impedance. A voltage drop is formed when the output current Iₒᵤₜ flows through the connection with the external impedance, and it increases due to the increasing output current Iₒᵤₜ. If the voltage of the mains electricity supply is not changed, the output terminal voltage Vₒᵤₜ₋ₜₑᵣₘ will increase due to the increasing the output current Iₒᵤₜ correspondingly. In addition, all the mains electricity supply, the output current Iₒᵤₜ, and the output terminal voltage Vₒᵤₜ₋ₜₑᵣₘ may be an alternating current or an alternating voltage. Under the circumstances, the increasing here refers to the increment of the maximum amplitude or the increment of the root mean square value.

According to the present embodiment, when the output current Iₒᵤₜ increases, the voltage at the output terminal increases correspondingly. For example, the external impedance may be a feeder. The impedance of the feeder increases with aging and the rising temperature. Hence, voltage across the feeder which acts as the impedance increases correspondingly when the output current Iₒᵤₜ increases.

As shown in FIG. 1A, the inverter 101 comprises a control unit 107. When the output terminal voltage Vₒᵤₜ₋ₜₑᵣₘ increases and falls within an alert range, the control unit 107 is configured to control the inverter 101 so as to reduce the output current Iₒᵤₜ. Alternatively, the current output current Iₒᵤₜ is maintained to prevent the output terminal voltage Vₒᵤₜ₋ₜₑᵣₘ from increasing and exceeding a voltage threshold value (that is to exceed an upper voltage limit of the alert range) which causes the inverter 101 to fall into a trip protection mechanism, for example, to avoid tripping the inverter 101 (i.e., to stop generating the output current Iₒᵤₜ) because of exceeding the voltage threshold value. It is noted that the trip protection mechanism may be the maximum power point tracking device or anti-islanding trip protection mechanism as mentioned above, and any mechanism that is able to stop the inverter 101 generating the output current Iₒᵤₜ is within the scope of the present invention.

In the present embodiment, the inverter 101 further comprises a judgment unit 103. When the judgment unit 103 determines that the output terminal voltage Vₒᵤₜ₋ₜₑᵣₘ falls within the alert range, the judgment unit 103 will generate an adjustment signal 102 and transmit the adjustment signal 102 to the control unit 107 in order to allow the control unit 107 adjusting the output current Iₒᵤₜ of the inverter 101 according to the adjustment signal 102.

In another embodiment, the judgment unit 103 can further calculate a judgment value according to the output current Iₒᵤₜ and the output terminal voltage Vₒᵤₜ₋ₜₑᵣₘ and generate the adjustment signal 102 according to the judgment value so as to adjust the output current Iₒᵤₜ of the inverter 101.

As shown in FIG. 1B, in another embodiment, the judgment unit 103 can be connected to the control unit 107 via a wired connection or a wireless connection. In greater detail, the judgment unit 103 may be electrically coupled to the control unit 107, or the judgment unit 103 may be disposed at a distant end and connected to the control unit 107 via a communication interface. The control unit 107 transmits the value of the output current Iₒᵤₜ and the output terminal voltage Vₒᵤₜ₋ₜₑᵣₘ to the judgment unit 103 via the wired connection or the wireless connection. For example as shown in FIG. 1B, the judgment unit 103 may be connected to the control unit 107 via a wireless network and transmit the adjustment signal 102 to the control unit 107 by remote control to allow the control unit 107 adjusting the output current Iₒᵤₜ according to the adjustment signal 102.

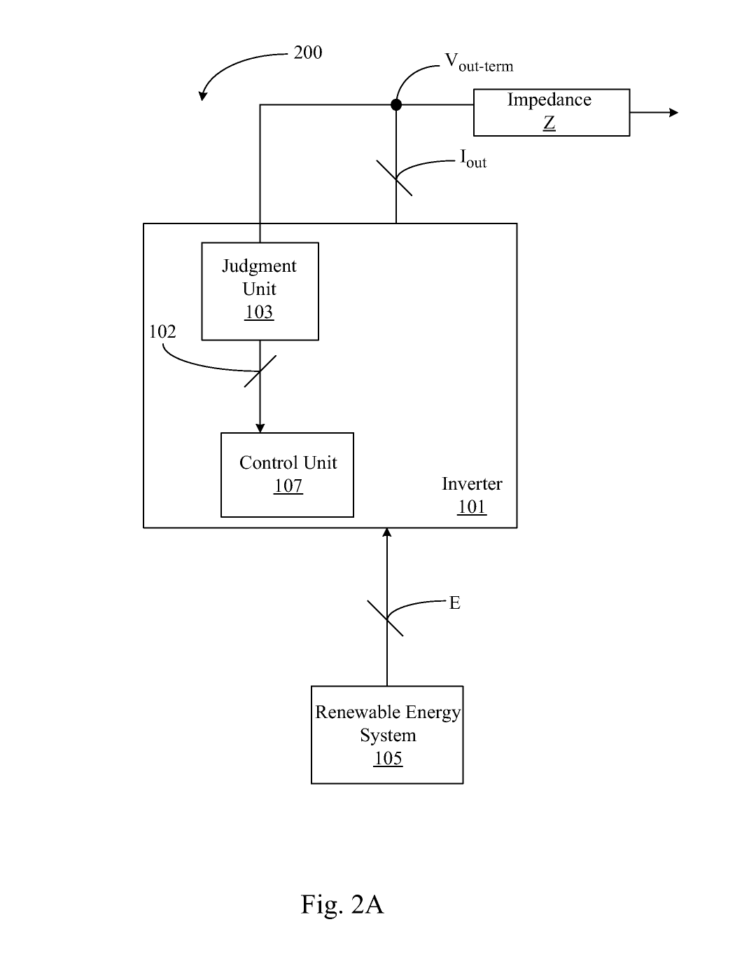

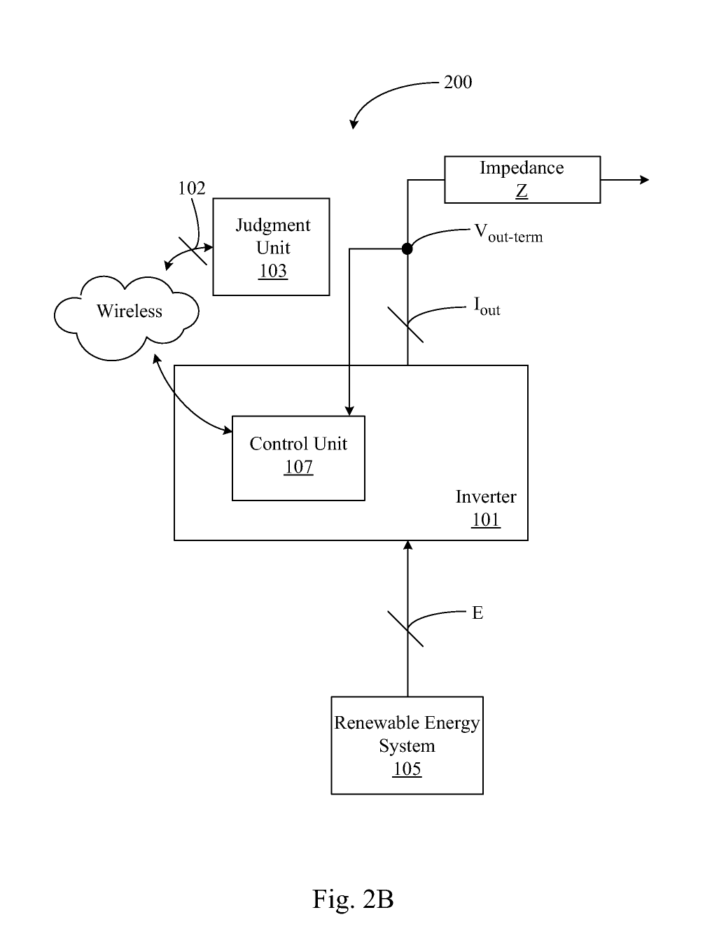

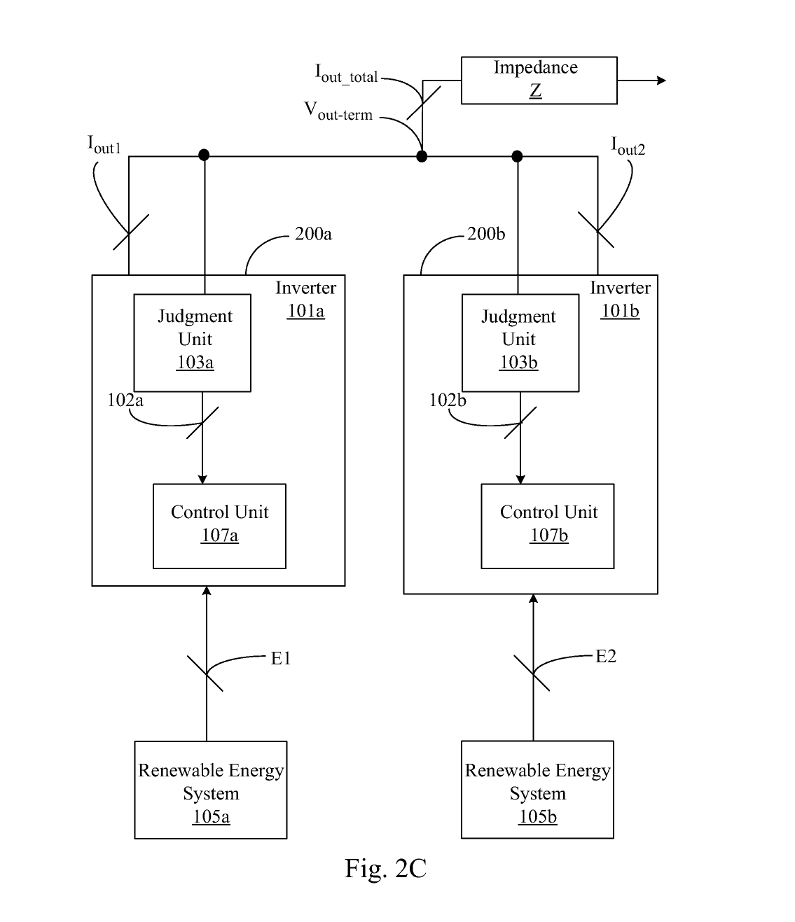

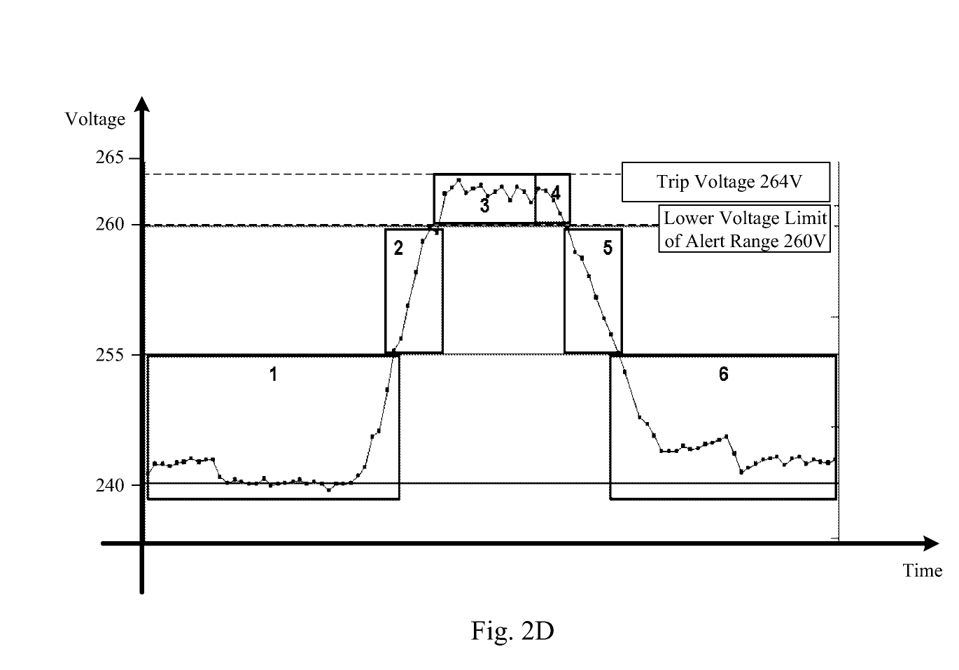

FIG. 2A depicts a schematic diagram of an inverting apparatus according to still another embodiment of this invention. FIG. 2B depicts a schematic diagram of an inverting apparatus according to yet another embodiment of this invention.

In the present embodiment, for example, a lower voltage limit of the alert range as mentioned above may be 260 volts, and the voltage threshold value as mentioned above may be 264 volts (i.e., the alert range is 260-264 volts, in other words, the alert range is between the lower voltage limit of the alert range and the voltage threshold value). When the output current Iₒᵤₜ remains increasing during a plurality of sample times and the output terminal voltage Vₒᵤₜ₋ₜₑᵣₘ is higher than the lower voltage limit of the alert range (i.e., 260 volts), the control unit 107 will control the inverter 101 reducing received amount of electrical energy E to decrease the output current Iₒᵤₜ or remaining the received amount of the electrical energy E to maintain the current output current Iₒᵤₜ so as to avoid the phenomenon that the output terminal voltage Vₒᵤₜ₋ₜₑᵣₘ exceeds the voltage threshold value 264 volts which causes the inverter 101 to fall into the trip protection mechanism as mentioned above.

When a plurality of sample values of the output current Iₒᵤₜ remains decreasing during a plurality of sample times and the output terminal voltage Vₒᵤₜ₋ₜₑᵣₘ is higher than the lower voltage limit of the alert range (i.e., 260 volts), the control unit 107 is configured to control the inverter 101 increasing the received amount of the electrical energy E, and the current output current Iₒᵤₜ is maintained.

In greater detail, as shown in FIG. 2A and FIG. 2B, the judgment unit 103 determines whether the output current Iₒᵤₜ increases or decreases during a plurality of sample times, and transmits the adjustment signal 102 to the control unit 107 to allow the control unit 107 to adjust the output current Iₒᵤₜ of the inverter 101 according to the adjustment signal 102. It is noted that the lower voltage limit of the alert range (i.e., 260 volts) and the voltage threshold value (i.e., 264 volts) as mentioned above are only for explanation of aspects of the present invention, and the present invention is not limited in this regard. As compared with FIG. 1A and FIG. 1B, an external impedance Z is depicted in FIG. 2A and FIG. 2B. Since the influence of the external impedance Z on the inverter 101 is similar to that in FIG. 1A and FIG. 1B, a description in this regard is not provided.

In one embodiment, when a plurality of sample values of the output terminal voltage Vₒᵤₜ₋ₜₑᵣₘ remains increasing during a plurality of sample times and the output terminal voltage Vₒᵤₜ₋ₜₑᵣₘ is higher than the lower voltage limit of the alert range (i.e., 260 volts), the control unit 107 controls the inverter 101 reducing the received amount of the electrical energy E to decrease the output current Iₒᵤₜ or remaining the received amount of the electrical energy E to maintain the output current Iₒᵤₜ.

In another embodiment, when the plurality of sample values of the output terminal voltage Vₒᵤₜ₋ₜₑᵣₘ remains decreasing during a plurality of sample times and the output terminal voltage Vₒᵤₜ₋ₜₑᵣₘ is higher than the lower voltage limit of the alert range (i.e., 260 volts), the control unit 107 further controls the inverter 101 increasing the received amount of the electrical energy E to increase the output current Iₒᵤₜ.

In other words, the judgment unit 103 determines whether the output terminal voltage Vₒᵤₜ₋ₜₑᵣₘ falls within the alert range during a plurality of sample times so as to generate the adjustment signal 102, and transmits the adjustment signal 102 to the control unit 107 to allow the control unit 107 to adjust the output current Iₒᵤₜ of the inverter 101 according to the adjustment signal 102.

In still another embodiment, when the output terminal voltage Vₒᵤₜ₋ₜₑᵣₘ is lower than the lower voltage limit of the alert range 260 volts, the control unit 107 controls the inverter 101 to allow the inverter 101 to achieve a maximum performance. By increasing the received amount of the electrical energy E, the output current Iₒᵤₜ is increased so that the inverter 101 generates a maximum output current Iₒᵤₜ but the output terminal voltage Vₒᵤₜ₋ₜₑᵣₘ does not exceed the voltage threshold value (i.e., 264 volts) at the same time. As a result, the inverter 101 is prevented from falling into a trip protection mechanism.

In yet another embodiment, the judgment unit 103 can further generate the adjustment signal 102 by judging the output current Iₒᵤₜ and the output terminal voltage Vₒᵤₜ₋ₜₑᵣₘ so as to adjust the output current Iₒᵤₜ of the inverter 101.

In greater detail, the inverter 101 converts the electrical energy E to the output current Iₒᵤₜ so as to generate the output terminal voltage Vₒᵤₜ₋ₜₑᵣₘ. The judgment unit 103 calculates a judgment value according to a ratio of a variance of the output terminal voltage Vₒᵤₜ₋ₜₑᵣₘ per unit voltage to a variance of the output current Iₒᵤₜ per unit current, wherein the variance of the output terminal voltage Vₒᵤₜ₋ₜₑᵣₘ per unit voltage is caused by the variance of the output current Iₒᵤₜ per unit current. Such the judgment value is a value of an impedance Z. That is, the value of the impedance Z=d(Vₒᵤₜ₋ₜₑᵣₘ)/d(Iₒᵤₜ). After that, the judgment unit 103 generates the adjustment signal 102 according to the value of the impedance Z.

If the value of the impedance Z is greater than a predetermined value, the impedance Z will cause a substantial influence on the output terminal voltage Vₒᵤₜ₋ₜₑᵣₘ when the output current Iₒᵤₜ increases. At this time, it is necessary to avoid that the inverter 101 falls into the trip protection mechanism due to the over high output terminal voltage Vₒᵤₜ₋ₜₑᵣₘ when the output current Iₒᵤₜ increases.

In another embodiment, the judgment unit 103 is further configured to compare the output terminal voltage Vₒᵤₜ₋ₜₑᵣₘ with the voltage threshold value 264 volts (that is the upper voltage limit of the alert range) so as to generate a comparison result and generate the adjustment signal 102 according to the judgment value and the comparison result.

In greater detail, if the value of the impedance Z is greater than the predetermined value and the output terminal voltage Vₒᵤₜ₋ₜₑᵣₘ is close to the voltage threshold value 264 volts (e.g., within the range of twenty percent below the voltage threshold value, within the range of ten percent below the voltage threshold value), the judgment unit 103 generates the adjustment signal 102 to allow the control unit 107 to decrease or remain the output current Iₒᵤₜ of the inverter 101.

In addition, the voltage threshold value may be the trip voltage of the inverter 101 (e.g., 264 volts) specified by electrical regulations. If the output terminal voltage Vₒᵤₜ₋ₜₑᵣₘ is about to exceed the voltage threshold value (e.g., the trip voltage 264 volts), it is necessary to stop generating or reduce the output current Iₒᵤₜ of the inverter 101. Hence, the inverter 101 is controlled by the adjustment signal 102 generated from the judgment unit 103 so as to limit the continuous rise of the output current Iₒᵤₜ.

FIG. 2C depicts a schematic diagram of cooperation between an inverting apparatus 200a and an inverting apparatus 200b according to one embodiment of this invention. As shown in FIG. 2C, for example, both a renewable energy system 105a and a renewable energy system 105b are solar regeneration systems. An inverter 101a and an inverter 101b respectively convert electrical energy E1 generated by the renewable energy system 105a and electrical energy E2 generated by the renewable energy system 105b to an output current Iₒᵤₜ₁ and an output current Iₒᵤₜ₂. A total output current Iₒᵤₜ_{_{—}}ₜₒₜₐₗ is thus generated and an output terminal voltage Vₒᵤₜ₋ₜₑᵣₘ is generated according to the total output current Iₒᵤₜ_{_{—}}ₜₒₜₐₗ.

When a judgment unit 103a and a judgment unit 103b determine that the output terminal voltage Vₒᵤₜ₋ₜₑᵣₘ falls within an alert range, the judgment unit 103a and the judgment unit 103b respectively generate an adjustment signal 102a and an adjustment signal 102b, and respectively transmit the adjustment signal 102a and the adjustment signal 102b to a control unit 107a and a control unit 107b so as to reduce the output current Iₒᵤₜ₁ generated by the inverter 101a and the output current Iₒᵤₜ₂ generated by the inverter 101b. The total output current Iₒᵤₜ_{_{—}}ₜₒₜₐₗ thus decreases. According to the present embodiment, it is understood that the present invention, when applied to power dispatch, can effectively remain the current quality of a power system so as to avoid the power generation losses of a renewable system.

FIG. 2D depicts a schematic diagram of a relationship between the output terminal voltage Vₒᵤₜ₋ₜₑᵣₘ of the inverting apparatus 200 shown as in FIG. 2A and time. The judgment unit 103 of the inverting apparatus 200 may perform judgments at different stages according to the relationship between the output terminal voltage Vₒᵤₜ₋ₜₑᵣₘ and time, such as the six judgment stages shown in FIG. 2D.

During the first stage, the output terminal voltage Vₒᵤₜ₋ₜₑᵣₘ is between 240 volts and 255 volts. The judgment unit 103 determines that the output terminal voltage Vₒᵤₜ₋ₜₑᵣₘ is normal. Hence, the judgment unit 103 does not allow the control unit 107 to adjust the output current Iₒᵤₜ but still remain detecting the situation of the rising output terminal voltage Vₒᵤₜ₋ₜₑᵣₘ. In another embodiment, the judgment unit 103 allows the control unit 107 to control the inverter 101 so as to increase the received amount of the electrical energy E and the magnitude of the output current Iₒᵤₜ (that is, the renewable energy system 105 is controlled to operate at the maximum possible power output).

During the second stage, the output terminal voltage Vₒᵤₜ₋ₜₑᵣₘ is higher than 255 volts when the output current Iₒᵤₜ increases. At this time, the judgment unit 103 determines that the second stage is an alert stage. Then, the judgment unit 103 determines that the output terminal voltage Vₒᵤₜ₋ₜₑᵣₘ does not exceed the lower voltage limit of the alert range 260 volts (that is, does not fall within the alert range). Hence, the judgment unit 103 does not allow the control unit 107 to adjust the output current Iₒᵤₜ but still remain detecting the situation of the rising output terminal voltage Vₒᵤₜ₋ₜₑᵣₘ. In another embodiment, the judgment unit 103 allows the control unit 107 to control the inverter 101 so as to increase the received amount of the electrical energy E and the magnitude of the output current Iₒᵤₜ (that is, the renewable energy system 105 is controlled to operate at the maximum possible power output).

During the third stage, the output terminal voltage Vₒᵤₜ₋ₜₑᵣₘ is greater than 260 volts. At this time, the judgment unit 103 determines that the output terminal voltage Vₒᵤₜ₋ₜₑᵣₘ falls within the alert range and the output terminal voltage Vₒᵤₜ₋ₜₑᵣₘ remains increasing. Then, the judgment unit 103 generates the adjustment signal 102 and transmits the adjustment signal 102 to the control unit 107. The control unit 107 controls the inverter 101 according to the adjustment signal 102 so as to decrease or remain the output current Iₒᵤₜ by reducing or maintaining the received amount of the electrical energy E.

In other words, the control unit 107 controls the inverter 101 to reduce or remain the electrical energy E generated by the renewable energy system 105. In this manner, less amount of the output current Iₒᵤₜ is converted by the inverter 101 correspondingly so as to achieve the effect of adjusting the output current Iₒᵤₜ. It is noted that the action of reducing the output current Iₒᵤₜ at the third stage can be remained performing until the output terminal voltage Vₒᵤₜ₋ₜₑᵣₘ no longer rises, or until the output terminal voltage Vₒᵤₜ₋ₜₑᵣₘ is within a range of allowable error of the alert range. As a result, the phenomenon that the inverter 101 falls into the trip protection mechanism because the renewable energy system 105 operates at the maximum power output which causes the whole system to stop outputting the electrical energy is avoided.

During the fourth stage, the output terminal voltage Vₒᵤₜ₋ₜₑᵣₘ is higher than the lower voltage limit of the alert range 260 volts. At this time, the judgment unit 103 determines that the output terminal voltage Vₒᵤₜ₋ₜₑᵣₘ is still within the alert range and the output terminal voltage Vₒᵤₜ₋ₜₑᵣₘ starts to decrease. The judgment unit 103 generates the adjustment signal 102 and transmits the adjustment signal 102 to the control unit 107. That is, under the premise that the inverter 101 will not fall into the trip protection mechanism, the maximum possible conversion energy output is maintained.

After that, the control unit 107 controls the inverter 101 to decrease or maintain the received amount of the electrical energy E generated by the renewable energy system 105 so that the inverter 101 does not fall into the trip protection mechanism because the output terminal voltage Vₒᵤₜ₋ₜₑᵣₘ of the inverter 101 exceeds the upper voltage limit of the alert range 264 volts.

During the fifth stage, the output terminal voltage Vₒᵤₜ₋ₜₑᵣₘ is higher than 255 volts but lower than 260 volts. At this time, the judgment unit 103 determines that the output terminal voltage Vₒᵤₜ₋ₜₑᵣₘ is lower than the lower voltage limit of the alert range 260 volts and the output terminal voltage Vₒᵤₜ₋ₜₑᵣₘ still remains decreasing. Hence, the judgment unit 103 determines that the fifth stage is an alert stage. Then, the judgment unit 103 transmits the adjustment signal 102 to the control unit 107. The control unit 107 controls the inverter 101 according to the adjustment signal 102. Under the circumstances, the target of adjusting the output current Iₒᵤₜ, again, becomes to obtain the maximum amount of renewable energy as possible. The control unit 107 thus controls the inverter to increase the output current Iₒᵤₜ by increasing the received amount of the electrical energy E.

During the sixth stage, the output terminal voltage Vₒᵤₜ₋ₜₑᵣₘ is between 240 volts and 255 volts. The judgment unit 103 determines that the output terminal voltage Vₒᵤₜ₋ₜₑᵣₘ is normal. Hence, the judgment unit 103 generates and transmits the adjustment signal 102 to the control unit 107 to allow the control unit 107 to control the inverter 101. By increasing the received amount of the electrical energy E, the output current Iₒᵤₜ is increased. It is noted that the various judgment stages as mentioned above are only for explanation of aspects of the present invention, and the voltage values as mentioned above and the sequence of the various judgment stages only serves as examples and are not intended to limit the scope of the present invention.

In another embodiment, the judgment unit 103 is further configured to compare the output current Iₒᵤₜ with a current threshold value and compare the output terminal voltage Vₒᵤₜ₋ₜₑᵣₘ with another voltage threshold value (e.g., the lower voltage limit of the alert range 260 volts) so as to generate a comparison result, and generate the adjustment signal 102 according to the judgment value and the comparison result.

As shown in FIG. 2D, during the first stage, the output terminal voltage Vₒᵤₜ₋ₜₑᵣₘ is between 240 volts and 255 volts. The judgment unit 103 calculates the impedance Z according to a ratio of a variance of the output terminal voltage Vₒᵤₜ₋ₜₑᵣₘ per unit voltage to a variance of the output current Iₒᵤₜ per unit current, wherein the variance of the output terminal voltage Vₒᵤₜ₋ₜₑᵣₘ per unit voltage is caused by the variance of the output current Iₒᵤₜ per unit current. At this time, the value for the impedance Z calculated by the judgment unit 103 is not greater than the predetermined value. The judgment unit 103 determines that the output terminal voltage Vₒᵤₜ₋ₜₑᵣₘ is normal. Hence, the judgment unit 103 does not allow the control unit 107 to adjust the output current Iₒᵤₜ but still remain detecting the situations of the rising impedance Z, the rising output current Iₒᵤₜ, and the rising output terminal voltage Vₒᵤₜ₋ₜₑᵣₘ.

During the second stage, the output terminal voltage Vₒᵤₜ₋ₜₑᵣₘ is higher than 255 volts but does not exceed the lower voltage limit of the alert range 260 volts when the output current Iₒᵤₜ increases. At this time, the judgment unit 103 determines that the value of the impedance Z calculated by the judgment unit 103 is greater than the predetermined value and determines the second stage to be an alert stage. Then, the judgment unit 103 compares the output current Iₒᵤₜ with the current threshold value, compares the output terminal voltage Vₒᵤₜ₋ₜₑᵣₘ with the lower voltage limit of the alert range 260 volts, and generates the comparison result. When the comparison result indicates that both the output current Iₒᵤₜ and the output terminal voltage Vₒᵤₜ₋ₜₑᵣₘ are within normal ranges, that is do not fall within the alert range, the judgment unit 103 does not allow the control unit 107 to adjust the output current Iₒᵤₜ but still remain detecting the situations of the rising impedance Z, the rising output current Iₒᵤₜ, and the rising output terminal voltage Vₒᵤₜ₋ₜₑᵣₘ.

During the third stage, the output terminal voltage Vₒᵤₜ₋ₜₑᵣₘ is higher than 260 volts. At this time, the judgment unit 103 determines that the value for the impedance Z calculated by the judgment unit 103 is greater than the predetermined value, and the output current Iₒᵤₜ and the output terminal voltage Vₒᵤₜ₋ₜₑᵣₘ remain increasing. The judgment unit 103 determines that the third stage to be an alert stage. Then, the judgment unit 103 compares the output current Iₒᵤₜ with the current threshold value and compares the output terminal voltage Vₒᵤₜ₋ₜₑᵣₘ with the lower voltage limit of the alert range 260 volts. When the judgment unit 103 determines that a value of the output current Iₒᵤₜ is higher than the current threshold value and the output terminal voltage Vₒᵤₜ₋ₜₑᵣₘ is higher than the lower voltage limit of the alert range 260 volts, the judgment unit 103 transmits the adjustment signal 102 to the control unit 107.

The control unit 107 controls the inverter 101 according to the adjustment signal 102 so as to decrease the output current Iₒᵤₜ by reducing the received amount of the electrical energy E. In other words, the control unit 107 controls the inverter 101 to reduce the received amount of the electrical energy E generated by the renewable energy system 105. In this manner, less amount of the output current Iₒᵤₜ is converted by the inverter 101 correspondingly so as to achieve the effect of adjusting the output current Iₒᵤₜ. It is noted that the action of reducing the output current Iₒᵤₜ at the third stage will be kept performing until the output terminal voltage Vₒᵤₜ₋ₜₑᵣₘ no longer rises, or until the output terminal voltage Vₒᵤₜ₋ₜₑᵣₘ is within a range of allowable error of the alert range

During the fourth stage, the output terminal voltage Vₒᵤₜ₋ₜₑᵣₘ is higher than the lower voltage limit of the alert range 260 volts. At this time, the judgment unit 103 determines that the value of the impedance Z calculated by the judgment unit 103 is greater than the predetermined value then determines the fourth stage to be an alert stage. Then, the judgment unit 103 compares the output current Iₒᵤₜ with the current threshold value and compares the output terminal voltage Vₒᵤₜ₋ₜₑᵣₘ with the lower voltage limit of the alert range 260 volts. When the comparison result indicates that the output terminal voltage Vₒᵤₜ₋ₜₑᵣₘ remains decreasing but is still higher than the lower voltage limit of the alert range 260 volts, the output current Iₒᵤₜ is remained the same, that is, not to change the output current Iₒᵤₜ. The judgment unit 103 may also transmit the adjustment signal 102 to the control unit 107.

The control unit 107 controls the inverter 101 to reduce the received amount of the electrical energy E generated by the renewable energy system 105 so as to adjust the output current Iₒᵤₜ. Hence, the inverter 101 does not fall into the trip protection mechanism because the output terminal voltage Vₒᵤₜ₋ₜₑᵣₘ of the inverter 101 exceeds the alert range.

During the fifth stage, the output terminal voltage Vₒᵤₜ₋ₜₑᵣₘ is higher than 255 volts but lower than the lower voltage limit of the alert range 260 volts. At this time, the judgment unit 103 determines that the value of the impedance Z calculated by the judgment unit 103 is greater than the predetermined value and the output current Iₒᵤₜ and the output terminal voltage Vₒᵤₜ₋ₜₑᵣₘ remain decreasing. The judgment unit 103 determines that the fifth stage to be an alert stage. After that, the judgment unit 103 compares the output current Iₒᵤₜ with the current threshold value and compares the output terminal voltage Vₒᵤₜ₋ₜₑᵣₘ with the lower voltage limit of the alert range 260 volts. When the judgment unit 103 determines that the value of the output current Iₒᵤₜ is lower than the current threshold value and the value of the output terminal voltage Vₒᵤₜ₋ₜₑᵣₘ is lower than the lower voltage limit of the alert range 260 volts, the judgment unit 103 transmits the adjustment signal 102 to the control unit 107. The control unit 107 thus controls the inverter 101 according to the adjustment signal 102. Under the circumstances, the target of adjusting the output current Iₒᵤₜ, again, becomes to obtain the maximum amount of renewable energy as possible.

During the sixth stage, the output terminal voltage Vₒᵤₜ₋ₜₑᵣₘ is between 240 volts and 255 volts. When the judgment unit 103 determines that the value of the impedance Z calculated by the judgment unit 103 is not greater than the predetermined value, the judgment unit 103 determines that the output terminal voltage Vₒᵤₜ₋ₜₑᵣₘ is normal. Hence, the judgment unit 103 does not allow the control unit 107 to control the output current Iₒᵤₜ but still remain detecting the situations of the rising impedance Z, the rising output current Iₒᵤₜ, and the rising output terminal voltage Vₒᵤₜ₋ₜₑᵣₘ.

In another embodiment, the inverter 101 converts the electrical energy E to the output current Iₒᵤₜ so as to generate the output terminal voltage Vₒᵤₜ₋ₜₑᵣₘ. The judgment unit 103 compares the output terminal voltage Vₒᵤₜ₋ₜₑᵣₘ with a lower voltage limit of at least one alert range to calculate at least one judgment value and generate the adjustment signal 102 so as to allow the control unit 107 to adjust the output current Iₒᵤₜ in sequence.

For example, when the output terminal voltage Vₒᵤₜ₋ₜₑᵣₘ exceeds the lower voltage limit of the at least one alert range, the judgment unit 103 generates the adjustment signal 102 for decreasing the output current Iₒᵤₜ one level down. The control unit 107 remains receiving the adjustment signal 102 for decreasing the output current Iₒᵤₜ when the output terminal voltage Vₒᵤₜ₋ₜₑᵣₘ increases until the output terminal voltage Vₒᵤₜ₋ₜₑᵣₘ no longer increases or does not exceed the lower voltage limit of at least one alert range.

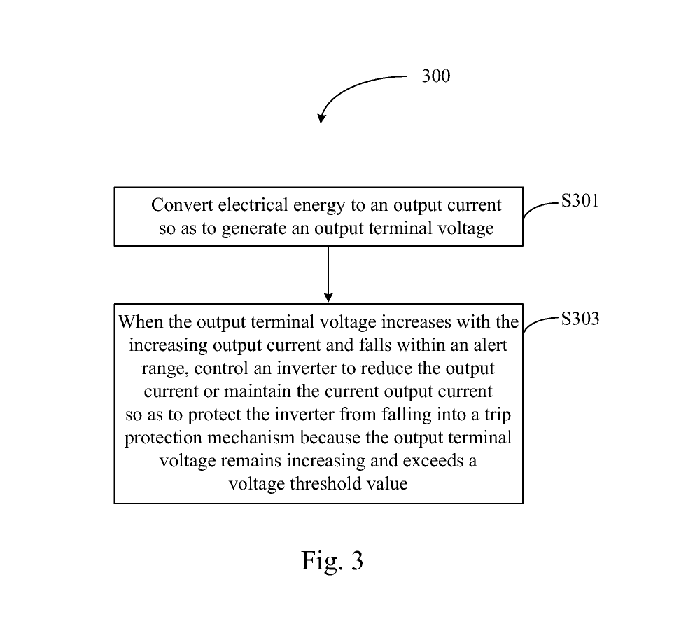

FIG. 3 depicts a flow chart of a control method 300 of an inverting apparatus according to one embodiment of this invention. It should be understood that the sequence of the steps described in the control method of the present embodiment, unless otherwise specified, may be changed as required by practical needs, or the steps or part of the steps may be performed simultaneously. In addition, the present embodiment may be realized by the various inverting apparatuses of the embodiments as mentioned above.

In step S301, convert electrical energy to an output current so as to generate an output terminal voltage. Then, in step S303, when the output terminal voltage increases with the increasing output current and falls within an alert range, control an inverter to reduce the output current or remain the current output current so as to protect the inverter from falling into a trip protection mechanism because the output terminal voltage remains increasing and exceeds a voltage threshold value.

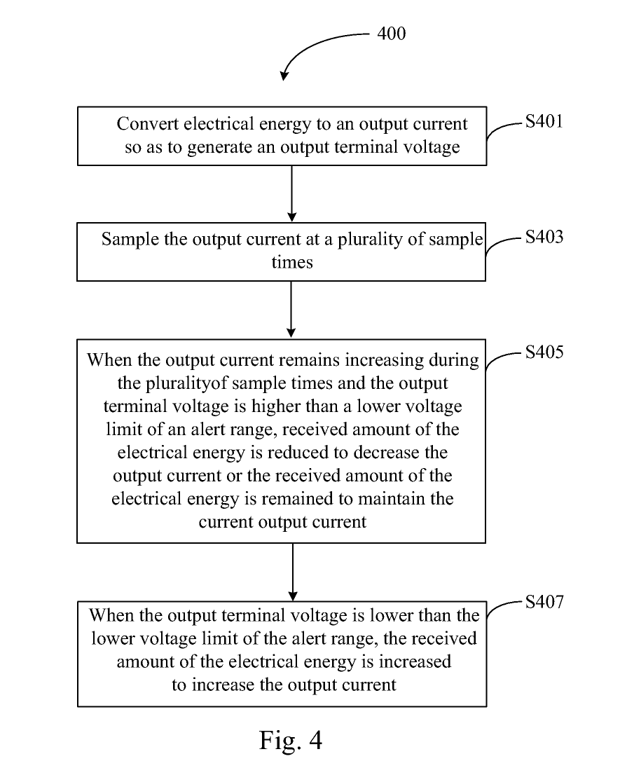

FIG. 4 depicts a flow chart of a control method 400 of an inverting apparatus according to another embodiment of this invention.

First, step S401 is performed to convert electrical energy to an output current so as to generate an output terminal voltage. Then, step S403 is performed to sample the output current at a plurality of sample times. In step S405, when a plurality of sample values of the output current remains increasing during the plurality of sample times and the output terminal voltage is higher than a lower voltage limit of an alert range, received amount of the electrical energy is reduced to decrease the output current or the received amount of the electrical energy is remained to maintain the current output current. In step S407, when the output terminal voltage is lower than the lower voltage limit of the alert range, the received amount of the electrical energy is increased to increase the output current.

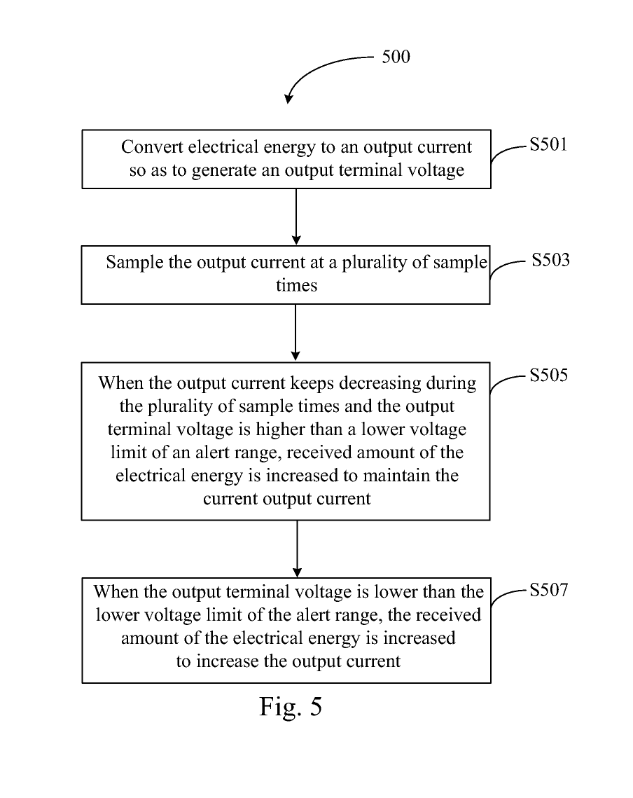

FIG. 5 depicts a flow chart of a control method 500 of an inverting apparatus according to still another embodiment of this invention.

First, step S501 is performed to convert electrical energy to an output current so as to generate an output terminal voltage. Then, step S503 is performed to sample the output current at a plurality of sample times. In step S505, when the plurality of sample values of the output current remains decreasing during the plurality of sample times and the output terminal voltage is higher than a lower voltage limit of an alert range, received amount of the electrical energy is increased to maintain the current output current. In step S507, when the output terminal voltage is lower than the lower voltage limit of the alert range, the received amount of the electrical energy is increased to increase the output current.

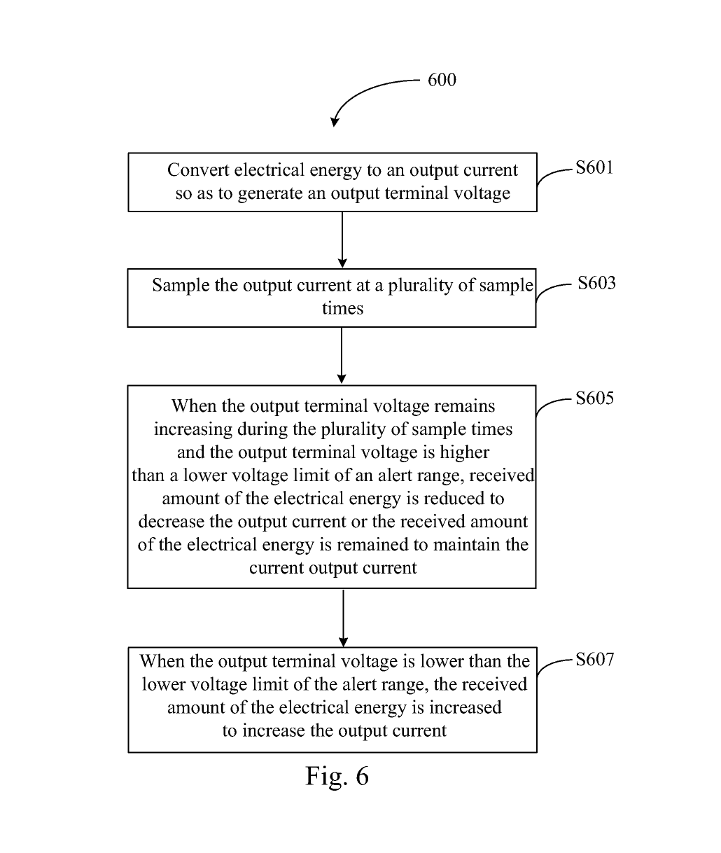

FIG. 6 depicts a flow chart of a control method 600 of an inverting apparatus according to yet another embodiment of this invention.

First, step S601 is performed to convert electrical energy to an output current so as to generate an output terminal voltage. Then, step S603 is performed to sample the output current at a plurality of sample times. In step S605, when a plurality of sample values of the output terminal voltage remains increasing during the plurality of sample times and the output terminal voltage is higher than a lower voltage limit of an alert range, received amount of the electrical energy is reduced to decrease the output current or the received amount of the electrical energy is maintained to maintain the current output current. In step S607, when the output terminal voltage is lower than the lower voltage limit of the alert range, the received amount of the electrical energy is increased to increase the output current.

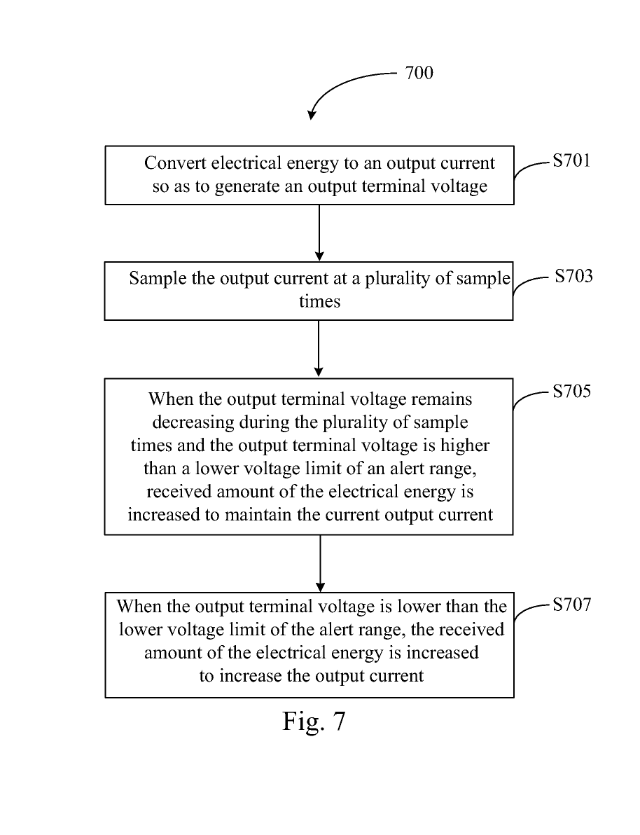

FIG. 7 depicts a flow chart of a control method 700 of an inverting apparatus according to another embodiment of this invention.

First, step S701 is performed to convert electrical energy to an output current so as to generate an output terminal voltage. Then, step S703 is performed to sample the output current at a plurality of sample times. In step S705, when the plurality of sample values of the output terminal voltage remains decreasing during the plurality of sample times and the output terminal voltage is higher than a lower voltage limit of an alert range, received amount of the electrical energy is increased to maintain the current output current. In step S707, when the output terminal voltage is lower than the lower voltage limit of the alert range, the received amount of the electrical energy is increased to increase the output current.

In addition, the control methods 300, 400, 500, 600, 700 described in the embodiments as mentioned above can also execute all the operations and functions executed by the inverting apparatuses 100, 200 according to the embodiments as mentioned above. Those of ordinary of skill in the art will readily appreciate how these operations and functions are executed, and a description in this regard is not provided.

According to the above embodiments, the inverting apparatus and the control method thereof according to the present invention can avoid the inverter operating alternatively in either the normal power supply mode or the trip protection mode because of the voltage difference effect caused by the impedance of the feeder. By controlling the control unit to control the output current of the inverter, the output terminal voltage is prevented from increasing and exceeding the alert range so as to avoid that the inverter falls into the trip protection mechanism. When the output terminal voltage increases and falls within the alert range, the control unit will remain, increase, or reduce the amount of output current received from the renewable energy so as to maintain, increase, or reduce the output current of the inverter correspondingly. As a result, the quality of current generated by the inverter is effectively maintained to avoid the power generation losses of a renewable system.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An inverting apparatus, comprising:
an inverter configured to convert electrical energy to an output current so as to generate an output terminal voltage, the output terminal voltage increasing correspondingly when the output current increases;
wherein the inverter comprises a control unit configured to control the inverter to decrease the output current or maintain the output current when the output terminal voltage increases and falls within an alert range to prevent the output terminal voltage from increasing and exceeding a voltage threshold value which causes the inverter to fall into a trip protection mechanism.

2. The inverting apparatus of claim 1, wherein when the output current remains increasing during a plurality of sample times and the output terminal voltage is higher than a lower voltage limit of the alert range, the control unit is further configured to control the inverter to decrease the output current by reducing received amount of the electrical energy or maintain the output current by remaining the received amount of the electrical energy.

3. The inverting apparatus of claim 2, wherein when the output terminal voltage is lower than the lower voltage limit of the alert range, the control unit is further configured to control the inverter to increase the output current by increasing the received amount of the electrical energy.

4. The inverting apparatus of claim 1, wherein when the output current remains decreasing during a plurality of sample times and the output terminal voltage is higher than a lower voltage limit of the alert range, the control unit is further configured to control the inverter to maintain the output current by increasing received amount of the electrical energy.

5. The inverting apparatus of claim 4, wherein when the output terminal voltage is lower than the lower voltage limit of the alert range, the control unit is further configured to control the inverter to increase the output current by increasing the received amount of the electrical energy.

6. The inverting apparatus of claim 1, wherein when the output terminal voltage remains increasing during a plurality of sample times and the output terminal voltage is higher than a lower voltage limit of the alert range, the control unit is further configured to control the inverter to decrease the output current by reducing received amount of the electrical energy or maintain the output current by remaining the received amount of the electrical energy.

7. The inverting apparatus of claim 6, wherein when the output terminal voltage is lower than the lower voltage limit of the alert range, the control unit is further configured to control the inverter to increase the output current by increasing the received amount of the electrical energy.

8. The inverting apparatus of claim 1, wherein when the output terminal voltage remains decreasing during a plurality of sample times and the output terminal voltage is higher than a lower voltage limit of the alert range, the control unit is further configured to control the inverter to maintain the output current by increasing received amount of the electrical energy.

9. The inverting apparatus of claim 8, wherein when the output terminal voltage is lower than the lower voltage limit of the alert range, the control unit is further configured to control the inverter to increase the output current by increasing the received amount of the electrical energy.

10. A control method of an inverting apparatus, comprising:
converting electrical energy to an output current so as to generate an output terminal voltage; and
controlling an inverter to decrease the output current or maintain the output current when the output terminal voltage increases with increasing of the output current and falls within an alert range to prevent the output terminal voltage from increasing and exceeding a voltage threshold value which causes the inverter to fall into a trip protection mechanism.

11. The control method of claim 10, further comprising:
increasing the received amount of the electrical energy to increase the output current when the output terminal voltage is lower than the lower voltage limit of the alert range.

12. The control method of claim 10, wherein controlling the inverter to decrease the output current or maintain the output current when the output terminal voltage increases with increasing of the output current and falls within the alert range to prevent the output terminal voltage from exceeding the voltage threshold value which causes the inverter to fall into the trip protection mechanism comprises:
sampling the output current at a plurality of sample times; and
reducing received amount of the electrical energy to decrease the output current or remaining the received amount of the electrical energy to maintain the output current when the output current remains increasing during the plurality of sample times and the output terminal voltage is higher than a lower voltage limit of the alert range.

13. The control method of claim 12, further comprising:
increasing the received amount of the electrical energy to increase the output current when the output terminal voltage is lower than the lower voltage limit of the alert range.

14. The control method of claim 10, wherein controlling the inverter to decrease the output current or maintain the output current when the output terminal voltage increases with increasing of the output current and falls within the alert range to prevent the output terminal voltage from exceeding the voltage threshold value which causes the inverter to fall into the trip protection mechanism comprises:
sampling the output current at a plurality of sample times; and
increasing received amount of the electrical energy to maintain the output current when the output current remains decreasing during the plurality of sample times and the output terminal voltage is higher than a lower voltage limit of the alert range.

15. The control method of claim 14, further comprising:
increasing the received amount of the electrical energy to increase the output current when the output terminal voltage is lower than the lower voltage limit of the alert range.

16. The control method of claim 10, wherein controlling the inverter to decrease the output current or maintain the output current when the output terminal voltage increases with increasing of the output current and falls within the alert range to prevent the output terminal voltage from exceeding the voltage threshold value which causes the inverter to fall into the trip protection mechanism comprises:
sampling the output current at a plurality of sample times; and
reducing received amount of the electrical energy to decrease the output current or remaining the received amount of the electrical energy to maintain the output current when the output terminal voltage remains increasing during the plurality of sample times and the output terminal voltage is higher than a lower voltage limit of the alert range.

17. The control method of claim 16, further comprising:
increasing the received amount of the electrical energy to increase the output current when the output terminal voltage is lower than the lower voltage limit of the alert range.

18. The control method of claim 10, wherein controlling the inverter to decrease the output current or maintain the output current when the output terminal voltage increases with increasing of the output current and falls within the alert range to prevent the output terminal voltage from exceeding the voltage threshold value which causes the inverter to fall into the trip protection mechanism comprises:
sampling the output current at a plurality of sample times; and
increasing received amount of the electrical energy to maintain the output current when the output terminal voltage remains decreasing during the plurality of sample times and the output terminal voltage is higher than a lower voltage limit of the alert range.

19. The control method of claim 18, further comprising the following step:
increasing the received amount of the electrical energy to increase the output current when the output terminal voltage is lower than the lower voltage limit of the alert range.
